(19) United States
(12) Patent Application Publication
(10) Pub. No.: US 2003/0055947 A1
(43) Pub. Date: Mar. 20, 2003

(54) Address conversion apparatus, monitoring apparatus, and computer-readable medium storing a program thereof

(76) Inventor: Jun Haneda, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(21) Appl. No.: 09/683,100

(22) Filed: Nov. 19, 2001

(30) Foreign Application Priority Data
Aug. 31, 2001 (JP) 2001-263999

(51) Int. Cl. G06F 15/173; G06F 15/16

(52) U.S. Cl. 709/224; 709/246

(57) ABSTRACT

An address conversion apparatus that connects a first network to a second network. A receiving unit receives a first SNMP trap from a communication apparatus on the first network and a converter changes a predetermined part of the first trap to generate a second SNMP trap. A transmitting unit transmits the second SNMP trap generated by the converter to a monitoring apparatus of the communication apparatus in the second network.

### CROSS REFERENCE TO RELATED APPLICATIONS

This patent application claims priority from a Japanese patent application, No. 2001-263999 filed on Aug. 31, 2001, the contents of which are incorporated herein by reference.

### BACKGROUND OF THE INVENTION

1. Field of the Invention

The present invention relates to an address conversion apparatus, a monitoring apparatus and a computer-readable medium storing a program thereof. More particularly, the present invention relates to processing an SNMP trap from a communication apparatus in a computer network to generate another SNMP trap thereof such that the communication apparatus can be identified by a network communication monitoring apparatus.

2. Description of the Related Art

SNMP (simple network management protocol) is widely used to manage a communication apparatus, such as a computer, a router, or a hub, on a network by a management apparatus connected to the network. In an SNMP-based system, the communication apparatus transmits an SNMP trap to a monitoring apparatus when a specific event occurs and thereby can notify that the event has occurred. The event may be, for example, ON/OFF of a power supply, failure information, or information of detection of a predetermined specified status.

In Japanese patent application Laid-Open No. 2000-59385, when plural systems are managed by a single manager, proxy management apparatuses are provided between the systems and a monitoring apparatus. A system ID of a system to be specified is added to communication between the proxy management apparatuses and the monitoring apparatus. Accordingly, the managing apparatus can specify and identify each system even when IP addresses overlap among the systems.

In the aforementioned Japanese patent application, since the system ID is added to an SNMP trap, it is required to convert the SNMP packet by adding a new field or part on the SNMP packet. When a LAN and a WAN are connected by using an address conversion apparatus, such as a router, it is preferable that conversion process of a packet be simplified to reduce protocol processing overhead and to reduce the amount of the system hardware.

### SUMMARY OF INVENTION

Therefore, it is an object of the present invention to provide an address conversion apparatus, a monitoring apparatus and a computer-readable medium storing a program thereof, which are capable of overcoming the above drawbacks accompanying the conventional art. The above and other objects can be achieved by combinations described in the independent claims. The dependent claims define further advantageous and exemplary combinations of the present invention.

According to the present invention, an address conversion apparatus for connecting a first network to a second network, includes: a receiving unit that receives a first SNMP trap from a communication apparatus in the first network; a converter that changes a predetermined part in the first trap to generate a second SNMP trap; and a transmitting unit that transmits the second trap generated by the converter to a monitoring apparatus of the communication apparatus in the second network.

In an aspect of the present invention, the converter changes the predetermined part of an agent address part in the first trap to a value corresponding to an address in the second network to generate the second SNMP trap.

In another aspect of the present invention, the converter changes the predetermined part of a time stamp part in the first trap to information for identifying the communication apparatus in the first network to generate the second trap.

In still another aspect of the present invention, the converter changes the predetermined part of a port number in the first trap to information for identifying the communication apparatus in the first network to generate the second trap.

In still another aspect of the present invention, the converter changes the predetermined part in the first trap to information for identifying the address conversion apparatus to generate the second SNMP trap.

In still another aspect of the present invention, the converter changes the predetermined part of a time stamp part in the first trap to the information for identifying the address conversion apparatus to generate the second trap.

In still another aspect of the present invention, the converter changes the predetermined part of a port number in the first trap to the information for identifying the address conversion apparatus to generate the second trap.

According to the present invention, an address conversion apparatus for connecting a first network to a second network, includes: a receiving unit that receives a first SNMP trap from a communication apparatus in the first network; a holding unit that holds the first trap; a transmitting unit that transmits a second SNMP trap based on the first SNMP trap to a monitoring apparatus of the communication apparatus in the second network; and a reading unit that reads the first trap from the holding unit in response to a read request of the first trap, corresponding to the second trap, from the monitoring apparatus, and transmits the first trap to the monitoring apparatus.

According to the present invention, an address conversion apparatus for connecting a first network to a second network, includes: an address management unit that manages one or more addresses allocated to the address conversion apparatus; a receiving unit that receives a first SNMP trap from a communication apparatus in the first network; a holding unit that holds the first trap; a converter that changes an agent address part in the first trap to one of the one or more addresses managed by the address management unit to generate a second SNMP trap; and a transmitting unit that transmits the second trap generated by the converter to a monitoring apparatus in the second network, in which the address management unit sets a status of the one of the one or more addresses to generate the second trap to “in use”, and when a status of each of the one or more addresses managed by the address management unit is “in use”, the converter does not generate the second trap.

In another aspect of the present invention, the address management unit receives, from the monitoring apparatus, trap processing completion information for setting the “in use” status of the one or more addresses to “no use”, and sets the status of the one or more addresses specified by the trap processing completion information to “no use”.

In still another aspect of the present invention, after the status of the one or more addresses is set to “in use”, the address management unit detects a previously specified passage of time and sets the “in use” status of the one or more addresses to “no use”.

In still another aspect of the present invention, the address management unit obtains an agent address from the first trap received from the communication apparatus in the first network, and records correspondence of the agent address to the one of the one or more addresses to generate the second trap, and the address conversion apparatus further includes: an inverter that changes a destination address of a first packet from the monitoring apparatus to the agent address, when the destination address of the first packet from the monitoring apparatus is the one of the one or more addresses managed by the address management unit, to generate a second packet; and a transfer unit that transfers the second packet to the communication apparatus in the first network.

According to the present invention, a monitoring apparatus receiving an SNMP trap transmitted by a communication apparatus via an address conversion apparatus, wherein the monitoring apparatus includes a specifying unit that specifies the communication apparatus based on an agent address part and a time stamp part in the trap.

According to the present invention, a monitoring apparatus receiving an SNMP trap transmitted by a communication apparatus via an address conversion apparatus, wherein the monitoring apparatus includes a specifying unit that specifies the communication apparatus based on an agent address part and a port number in the trap.

According to the present invention, a monitoring apparatus receiving a generated SNMP trap from an address conversion apparatus, connecting a first network to a second network, which receives an SNMP trap from a communication apparatus in the first network, holds the trap, and transmits the generated trap, the monitoring apparatus includes: a receiving unit that receives the generated trap; and a transmitting unit that transmits a request to the address conversion apparatus to read the trap corresponding to the generated trap from the address conversion apparatus.

According to the present invention, a computer-readable medium storing an address conversion program for a computer connecting a first network to a second network, the program includes: a receiving module that directs the computer to receive a first SNMP trap from a communication apparatus in the first network; a conversion module that directs the computer to change a predetermined part in the first trap to generate a second SNMP trap; and a transmitting module that directs the computer to transmit the second trap generated by the computer to a monitoring apparatus of the communication apparatus in the second network.

According to the present invention, a computer-readable medium storing a program for a monitoring apparatus that receives an SNMP trap transmitted by a communication apparatus via an address conversion apparatus, wherein the program comprises a specifying module that is operable to make the monitoring apparatus specify the communication apparatus based on an agent address part and a time stamp part in the trap.

According to the present invention, a computer-readable medium storing a program for a monitoring apparatus that receives an SNMP trap transmitted by a communication apparatus via an address conversion apparatus, wherein the program comprises a specifying module that is operable to make the monitoring apparatus specify the communication apparatus based on an agent address part and a port number in the trap.

This summary of the present invention does not necessarily describe all necessary features so that the invention may also be a sub-combination of these described features.

### BRIEF DESCRIPTION OF DRAWINGS

FIG. 1 is a schematic depiction of one example of a communication system 100 in a first embodiment according to the present invention.

FIG. 2 shows schematically components in an address conversion apparatus 130a of the first embodiment in the present invention.

FIG. 3 is a schematic representation showing components in a monitoring apparatus 150 of the first embodiment in the present invention.

FIG. 4 is a diagram of an SNMP trap according to the first embodiment in the present invention.

FIGS. 5A-C show changes to an SNMP trap by a converter 210 of the first embodiment in the present invention.

FIGS. 6A-B shows other changes to the SNMP trap by the converter 210 of the first embodiment in the present invention.

FIG. 7 shows schematically components in the address conversion apparatus 130a in a second embodiment of the present invention.

FIG. 8 is a flowchart of a trap transfer processing according to the second embodiment in the present invention.

FIG. 9 shows schematically components in the address conversion apparatus 130a in a third embodiment of the present invention.

FIG. 10 shows one example of an address conversion table 945 according to the third embodiment in the present invention.

FIG. 11 is a flowchart of a trap processing in the address conversion apparatus 130a according to the third embodiment in the present invention.

FIG. 12 is a schematic depiction of one example of hardware components of the address conversion apparatus 130a or the monitoring apparatus 150 in a fourth embodiment of the present invention.

### DETAILED DESCRIPTION

The invention will now be described based on preferred embodiments, which do not intend to limit the scope of the present invention, but rather to exemplify the invention. All of the features and the combinations thereof described in the embodiments are not necessarily essential to the invention.

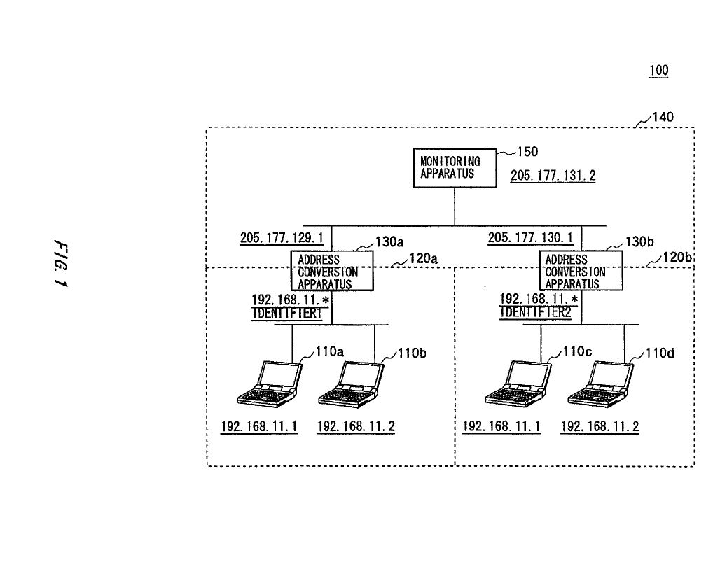

(First embodiment)FIG. 1 shows one example of communication system 100 in a first embodiment of the present invention. Communication system 100 of the present embodiment includes terminals 110a, 110b, 110c, and 110d, LANs 120a and 120b, address conversion apparatuses 130a and 130b, WAN 140 and monitoring apparatus 150.

Terminals 110a to 110d are one example of a communication apparatus according to the present invention. The communication apparatus of the present invention may be a communication apparatus having communication functions, such as a server, a hub, a bridge, a router, a gateway, other than the terminals 110a to 110d.

Terminals 110a to 110d transmit an SNMP trap to monitoring apparatus 150 when a specific event occurs in the terminals and inform that the event has occurred. The event is, for example, ON/OFF of a power supply, failure information, or information of detection of a predetermined status.

LAN 120a is a LAN (local area network) to connect terminals 110a to 110b to address conversion apparatus 130a. LAN 120b is a LAN to connect terminals 110c to 110d to address conversion apparatus 130b. Local IP address “192.168.11.*” is allocated to LAN 120a and LAN 120b of the present embodiment. In LAN 120a, local IP address “192.168.11.1” is allocated to terminal 110a and local IP address “192.168.11.2” is allocated to terminal 110b. In LAN 120b, local IP address “192.168.11.1” is allocated to terminal 110c and local IP address “192.168.11.2” is allocated to terminal 110d.

Address conversion apparatuses 130a to 130b are routers having a NAT (network address translator) function as one example of an address conversion function. The address conversion apparatus of the present invention may be a server, a bridge, a router, a gateway, or a NAT box.

Address conversion apparatuses 130a and 130b respectively connect LANs 120a and 120b, which are one example of a first network in the present invention, to WAN 140, which is one example of a second network in the present invention. In the present embodiment, since address conversion apparatuses 130a and 130b have the same constitution, address conversion apparatus 130a will mainly be described hereinafter.

WAN 140 is a WAN (wide area network) to connect address conversion apparatuses 130a to 130b to monitoring apparatus 150. In WAN 140 of the present embodiment, global IP address “205.1.77.129.1” is allocated to address conversion apparatus 130a, global IP address “205.177.130.1” is allocated to address conversion apparatus 130b, and global IP address “205.177.131.2” is allocated to monitoring apparatus 150.

Monitoring apparatus 150 monitors the status of terminals 110a to 110d by receiving traps transmitted by terminals 110a to 110d via address conversion apparatus 130a or address conversion 130b. Monitoring apparatus 150 may transmit a management message based on SNMP to terminals 110a to 110d in accordance with a trap received from one of the terminals 110a to 110d.

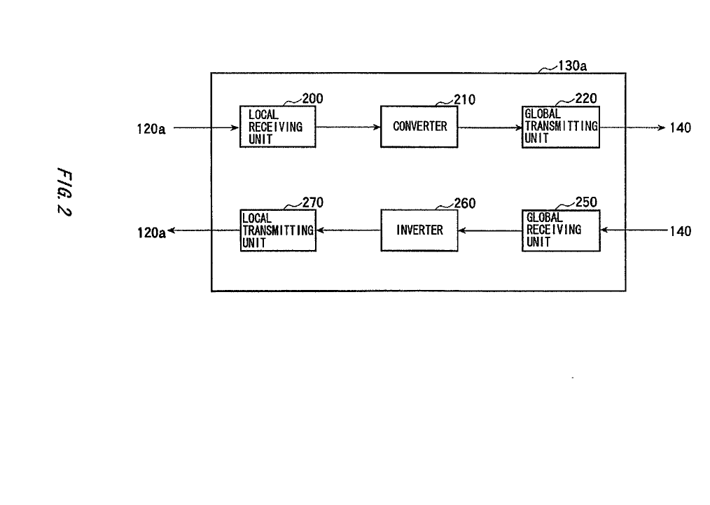

FIG. 2 shows address conversion apparatus 130a including local receiving unit 200, converter 210, global transmitting unit 220, global receiving unit 250, inverter 260 and local transmitting unit 270. Local receiving unit 200 is one example of a receiving unit in address conversion apparatus 130a of the present invention. Global transmitting unit 220 is one example of a transmitting unit in address conversion apparatus 130a in the present invention.

Local receiving unit 200 receives a first trap from terminals 110a to 110b, which are communication apparatuses in LAN 120a. Converter 210 changes a predetermined part of the first trap received by local receiving unit 200 to generate a second trap. Converter 210 generates the second trap in order that monitoring apparatus 150 can specify the terminal 110a or 110b from which the first trap is transmitted.

Global transmitting unit 220 transmits the second trap generated by converter 210 to monitoring apparatus 150 on WAN 140. Global receiving unit 250 receives a management message transmitted by monitoring apparatus 150 to terminal 110a or terminal 110b having transmitted the first trap. Inverter 260 converts a management message destination IP address received by global receiving unit 250 into a local IP address of terminal 110a or terminal 110b having transmitted the first trap. Local transmitting unit 270 transmits the management message converted by inverter 260, via LAN 120a, to terminal 110a or terminal 110b having transmitted the first trap.

Address conversion apparatus 130a may use, for example, the SET REQUEST message or the GET REQUEST message based on SNMP as the aforementioned management message.

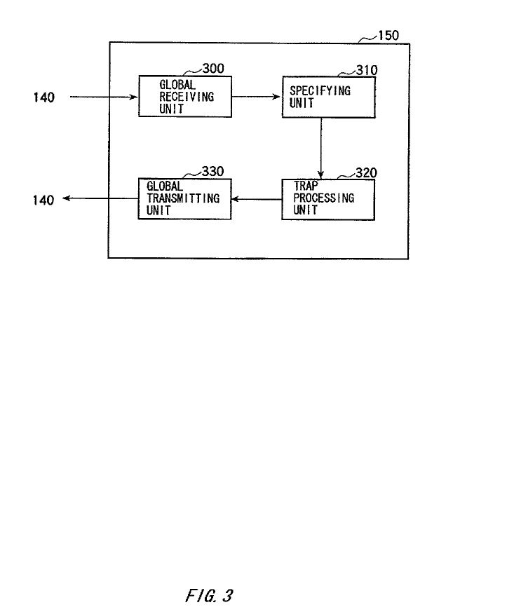

FIG. 3 shows monitoring apparatus 150 having global receiving unit 300, specifying unit 310, trap processor 320 and global transmitting unit 330. Global receiving unit 300 is one example of a receiving unit in monitoring apparatus 150 in the present invention. Global transmitting unit 330 is one example of a transmitting unit in monitoring apparatus 150 in the present invention.

Global receiving unit 300 receives the second trap transmitted by address conversion apparatus 130a or address conversion apparatus 130b, which received the first trap transmitted by terminals 110a to 110d. Specifying unit 310 analyzes the second trap received by global receiving unit 300 and specifies a communication apparatus having transmitted the corresponding first trap. Trap processor 320 processes the second trap, which corresponds to the first trap, and notifies a user of monitoring apparatus 150 of a content of the first trap, which was transmitted from any communication apparatus of terminals 110a to 110d; updates information with respect to the status of each of the terminals 110a to 110d stored in trap processor 320; or generates a management message to instruct an operation corresponding to the first trap. Global transmitting unit 330 transmits the management message generated by trap processor 320 to the communication apparatus of terminals 110a to 110d having transmitted the trap.

Monitoring apparatus 150 may use the SET REQUEST message or the GET REQUEST message based on SNMP as the aforementioned management message.

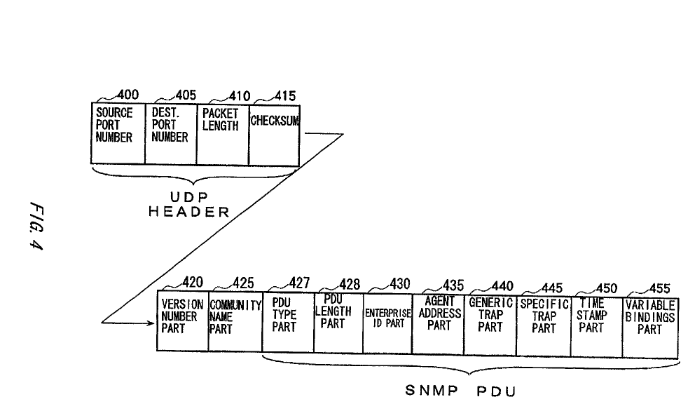

FIG. 4 is a diagram of a trap according to the first embodiment in the present invention. The trap of the present embodiment has source port number 400, destination port number 405, packet length 410, check sum 415, version number part 420, community name part 425, PDU type part 427, PDU length part 428, enterprise ID part 430, agent address part 435, generic trap part 440, specific trap part 445, time stamp part 450 and variable bindings part 455.

Source port number 400, destination port number 405, packet length 410 and check sum 415 are UDP (user data gram protocol) headers to transfer an SNMP trap. Source port number 400 is a port number to be used when terminals 110a to 110d transmit traps. Most communication apparatuses use 161 as source port number 400 in transmission of an SNMP trap. Destination port number 405 is a port number that is the destination of a trap. A monitoring apparatus generally uses 162 as the destination port number 405. Packet length 410 is a packet length of a trap. Check sum 415 is a check sum of a packet that is added to provide reliability of a trap's data.

Version number part 420, community name part 425, PDU type part 427, PDU length part 428, enterprise ID part 430, agent address part 435, generic trap part 440, specific trap part 445, time stamp part 450, and variable bindings part 455 are data of an SNMP trap. Version number part 420 is an SNMP version number. Community name part 425 is a community name.

PDU type part 427, PDU length part 428, enterprise ID part 430, agent address part 435, generic trap part 440, specific trap part 445, time stamp part 450, and variable bindings part 455 are a PDU (protocol data unit) showing a content of an SNMP trap. PDU type part 427 is a type of the PDU and holds an identifier that identifies that the PDU is a trap. PDU length part 428 is the length of the PDU. Enterprise ID part 430 contains an identifier showing a type of the communication apparatus having transmitted the trap. Agent address part 435 contains an IP address of the communication apparatus having transmitted the trap. Each of terminals 10a to 110d records a local IP address of the communication apparatus in agent address part 435 of a trap to transmit the local IP address as the first trap. Generic trap part 440 is an identifier showing a type of a generic trap.

Specific trap part 445 is an identifier showing a type of a trap that is defined by the manufacturer of the communication apparatus having transmitted the trap. Time stamp part 450 is the time when an event corresponding to the trap occurred in the communication apparatus having transmitted the trap, i.e., a time tick. Time stamp part 450 of the present embodiment contains the time when the event occurred per 1/100 seconds. Variable bindings part 455 contains a list of an OID (object ID) and it's value, which is a parameter in the communication apparatus relating to the trap.

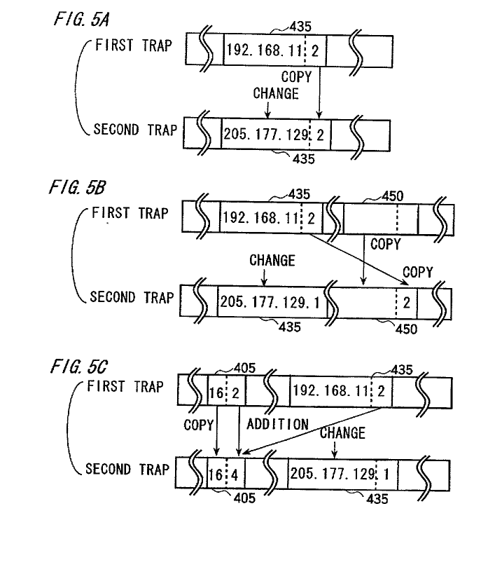

FIGS. 5A-C show changes to a trap by converter 210 in address conversion apparatus 130a of the first embodiment in the present invention.

Terminals 110a to 110b transmit value 162 as the destination port number 405 with the first trap, and transmit the first trap with the local IP address of the transmitting communication apparatus in agent address part 435 to monitoring apparatus 150. In FIGS. 5A-C, converter 210 in address conversion apparatus 130a changes the first trap so that a global IP address of address conversion apparatus 130a, which is information for identifying address conversion apparatus 130a in WAN 140, and a lower 1 byte of the local IP address, which is information for identifying terminal 110a or terminal 110b in LAN 120a, are included in the second trap. Specifying unit 310 in monitoring apparatus 150 can specify a transmission source of the first trap based on the second trap.

When address conversion apparatuses 130a to 130b do not change a trap transmitted by a terminal, monitoring apparatus 150 can not specify the transmission source of the trap. That is, agent address part 435 in a first trap transmitted by terminal 110b is “192.168.11.2”, which is its local IP address in LAN 120a. Agent address part 435 in a first trap transmitted by terminal 110d is also “192.168.11.2”, which is its local IP address in LAN 120b. When address conversion apparatuses 130a and 130b transmit the trap to monitoring apparatus 150 without change to the first trap, monitoring apparatus 150 can not specify whether the associated event occurred at terminal 110b or terminal 110d based on the original trap.

In FIG. 5A, converter 210 in the address conversion apparatus 130a changes a value for the upper three bytes in agent address part 435 of the first trap to a value corresponding to the global IP address of the address conversion apparatus 130a in WAN 140 and the changed value is the value of the upper three bytes in agent address part 435 of the second trap. Converter 210 copies a lower one byte in agent address part 435 of the first trap to a lower one byte in agent address part 435 of the second trap. Thereby, converter 210 can include information for identifying address conversion apparatus 130a in WAN 1 40 and information for identifying terminal 110a or terminal 110b in LAN 120a in the second trap. Therefore, specifying unit 310 in monitoring apparatus 150 can specify the transmission source of the first trap based on agent address part 435 of the second trap.

In particular, converter 210 changes each of the first traps transmitted by terminals 110a to 110d to corresponding second traps respectively having “205.177.129.1”, “205.177.129.2”, “205.177.130.1”, and “205.177.130.2” as agent address part 435. Therefore, specifying unit 310 in monitoring apparatus 150 can specify the communication apparatus having transmitted the first trap based on the second trap.

Converter 210 in address conversion apparatus 130a in the case shown in FIG. 5A changes a predetermined part of agent address part 435 in the first trap to a value corresponding to an address in WAN 140 to generate the second trap.

In FIG. 5B, converter 210 in address conversion apparatus 130a changes agent address part 435 of the first trap to a value corresponding to a global IP address on WAN 140 and the changed agent address part 435 is agent address part 435 of the second trap. Converter 210 copies the lower one byte in agent address part 435 of the first trap to a lower one byte in time stamp part 450 of the second trap. Thereby, converter 210 can include information for identifying address conversion apparatus 130a in WAN 140 and information for identifying terminal 110a or terminal 110b in LAN 120a in the second trap. Therefore, specifying unit 310 in monitoring apparatus 150 can specify the transmission source of the first trap based on agent address part 435 and time stamp part 450 of the second trap.

In particular, converter 210 changes a combination of agent address part 435 and a lower part of time stamp part 450 in the first traps transmitted by terminals 110a to 110d to “205.177.129.1,1”, “205.177.129.1,2”, “205.177.130.1,1”, and “205.177.130.1,2”, respectively, in the corresponding second traps. Therefore, specifying unit 310 in monitoring apparatus 150 can specify the communication apparatus having transmitted the first trap based on the second trap.

Converter 210 in address conversion apparatus 130a in the case shown in FIG. 5B changes a predetermined part of time stamp part 450 in the first trap to information for identifying the transmitting communication apparatus in LAN 120a to generate the second trap. Specifying unit 310 in monitoring apparatus 150 specifies the communication apparatus having transmitted the first trap based on agent address part 435 and time stamp part 450 in the second trap.

In FIG. 5C, converter 210 in address conversion apparatus 130a changes agent address part 435 of the first trap to a value corresponding to a global IP address on WAN 140 and the changed agent address part 435 is agent address part 435 of the second trap. Converter 210 adds the lower one byte in agent address part 435 and destination port number 405 of the first trap, and the added value is destination port number 405 in the second trap. Thereby, converter 210 can include information for identifying address conversion apparatus 130a in WAN 140 and information for identifying terminal 110a or terminal 110b in LAN 120a in the second trap. Therefore, specifying unit 310 in monitoring apparatus 150 can specify the transmission source of the first trap based on destination port number 405 and agent address part 435 of the second trap.

In particular, converter 210 changes a combination of agent address part 435 and destination port number 405 in the first traps transmitted by terminals 110a to 110d to “205.177.129.1,163”, “205.177.129.1,164”, “205.177.130.1,163”, and “205.177.130.1,164”, respectively, in the corresponding second traps. Therefore, specifying unit 310 in monitoring apparatus 150 can specify the communication apparatus having transmitted the first trap based on the second trap.

Converter 210 in address conversion apparatus 130a in the case of FIG. 5C changes a predetermined part of destination port number 405 of the first trap to information to specify the transmitting communication apparatus in LAN 120a to generate the second trap. Specifying unit 310 in monitoring apparatus 150 specifies the transmitting communication apparatus based on agent address part 435 and destination port number 405 in the second trap.

The trap changes of FIGS. 5A to 5C as aforementioned can be applied regardless of an IP address value or upper/lower byte width according to the present embodiment.

A trap change that combines the trap changes of FIGS. 5A to 5C also may be used for converter 210 and specifying unit 310. Converter 210 in address conversion apparatus 130a may include information for identifying terminal 110a or terminal 110b in LAN 120a in each one of a lower part of agent address part 435, a lower part of time stamp part 450, and destination port number 405.

When converter 210 includes the lower part of agent address part 435 of the first trap in agent address part 435 or time stamp part 450 of the second trap, converter 210 may include the lower part thereof in a quotient or a remainder part obtained from a preset number in address conversion apparatus 130a or 130b and monitoring apparatus 150. For example, when five communication apparatuses are connected to LAN 120a, the lower part of agent address part 435 of the first trap may be included in the surplus part of agent address part 435 or time stamp part 450 divided by 5.

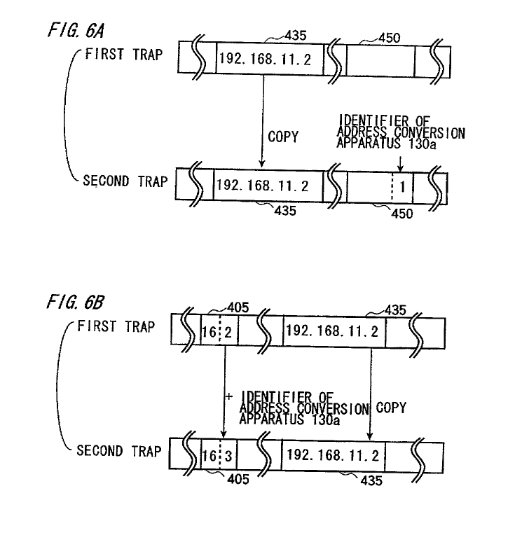

FIGS. 6A-B show other trap changes by converter 210 in address conversion apparatus 130a of the first embodiment in the present invention.

Terminals 110a to 110b transmit value 162 as destination port number 405 of the first trap, and transmit the first trap with the local IP address of the transmitting communication apparatus in agent address part 435 to monitoring apparatus 150. In FIGS. 6A-B, converter 210 in the address conversion apparatus 130a changes the first trap so that an identifier of address conversion apparatus 130a, which is information for identifying address conversion apparatus 130a in WAN 140, and a local IP address, which is information for identifying terminal 110a or terminal 110b in LAN 120a, are included in the second trap. Specifying unit 310 in monitoring apparatus 150 can specify the source of the first trap transmission based on the second trap.

In FIG. 6A, converter 210 in address conversion apparatus 130a uses agent address part 435 of the first trap as agent address part 435 of the second trap. Converter 210 changes the lower one byte in time stamp part 450 of the first trap to “1”, which is an identifier for monitoring apparatus 130a to identify address conversion apparatus 130a and the changed value is time stamp part 450 of the second trap. Converter 210 can include information for identifying address conversion apparatus 130a in WAN 140 and information for identifying terminal 110a or terminal 110b in LAN 120a in the second trap. Specifying unit 310 in monitoring apparatus 150 can specify the source of the first trap transmission based on agent address part 435 and time stamp part 450 of the second trap.

Converter 210 in address conversion apparatus 130a in the case of FIG. 6A changes the predetermined part of time stamp part 450 in the first trap to information for identifying address conversion apparatus 130a to generate the second trap.

In FIG. 6B, converter 210 in address conversion apparatus 130a uses agent address part 435 of the first trap as agent address part 435 of the second trap. Converter 210 adds “1”, which is the identifier for monitoring apparatus 150 to identify address conversion apparatus 130a, to destination port number 405 of the first trap, and the added value is destination port number 405 of the second trap. Thereby, converter 210 can include information for identifying address conversion apparatus 130a in WAN 140 and information for identifying terminal 110a or terminal 110b in LAN 120a in the second trap. Therefore, specifying unit 310 in monitoring apparatus 150 can specify the transmission source of the first trap based on destination port number 405 and agent address part 435 of the second trap.

Converter 210 in address conversion apparatus 130a in the case of FIG. 6B changes a predetermined part of destination port number 405 in the first trap to information for identifying address conversion apparatus 130a to generate the second trap.

The trap changes of FIGS. 6A and 6B as aforementioned can be applied regardless of an IP address value or IP address upper/lower byte width according to the present embodiment.

Combinations of the trap changes of FIGS. 6A and 6B may be used for converter 210 and specifying unit 310. In converter 210 in address conversion apparatus 130a, identifiers for monitoring apparatus 150 to identify address conversion apparatus 130a may be included in each one of the lower part of time stamp part 450 and destination port number 405.

When the identifier of address conversion apparatus 130a is included in, for example, time stamp part 450, converter 210 may include the identifier in a quotient or a remainder part of a preset number in address conversion apparatus 130a or 130b and monitoring apparatus 150. In particular, when five address conversion apparatuses are connected to WAN 140, the identifier of address conversion apparatus 130a may be included in the surplus part of time stamp part 450 divided by 5.

Any of the trap changes shown in FIGS. 5A to 5C or FIGS. 6A to 6B may be used for converter 210 of the present embodiment and monitoring apparatus 150 can specify the source of the first trap transmission.

According to the present embodiment, converter 210 in address conversion apparatuses 130a to 130b converts the first trap into the second trap. Thereby, monitoring apparatus 150 can specify the communication apparatus having transmitted the first trap. Since the second trap is also a trap and only a part of the first trap is changed, a change of packet length is not necessary and packet conversion processing can easily be realized.

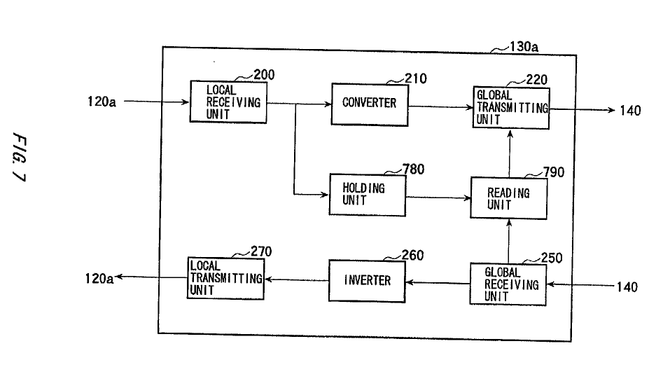

(Second embodiment)FIG. 7 shows address conversion apparatus 130a in a second embodiment of the present invention including local receiving unit 200, converter 210, global transmitting unit 220, global receiving unit 250, inverter 260, local transmitting unit 270, holding unit 780 and reading unit 790. Local receiving unit 200 is one example of a receiving unit in address conversion apparatus 130a in the present embodiment. Global transmitting unit 220 is one example of a transmitting unit in address conversion apparatus 130a in the present embodiment. Reading unit 790 and global transmitting unit 220 are one example of a reading unit in address conversion apparatus 130a of the present embodiment.

Local receiving unit 200 receives a first trap, which is an SNMP trap, from terminals 110a to 110b, which are communication apparatuses on LAN 120a.

Converter 210 changes a predetermined part of the first trap received by local receiving unit 200 to generate a second trap. Converter 210 generates the second trap in order that monitoring apparatus 150 can specify address conversion apparatus 130a transmitting the second trap. As one example, in the present embodiment converter 210 changes agent address part 435 of the first trap to the global IP address of address conversion apparatus 130a to generate the second trap.

Holding unit 780 holds the first trap received by local receiving unit 200. Global transmitting unit 220 transmits the second trap generated by converter 210 to monitoring apparatus 150 on WAN 140. Global receiving unit 250 receives a read request of the first trap transmitted by monitoring apparatus 150 when monitoring apparatus 150 receives the second trap and a management message transmitted by monitoring apparatus 150 to terminal 110a or terminal 110b having transmitted the first trap. Reading unit 790 reads the first trap from holding unit 780 based upon the read request of the first trap, and transmits data of the first trap to monitoring apparatus 150 by using global transmitting unit 220. Inverter 260 converts the management message destination IP address received by global receiving unit 250 into the local IP address of terminal 110a or terminal 110b having transmitted the first trap. Local transmitting unit 270 transmits the management message converted by inverter 260, via LAN 120a, to terminal 110a or terminal 110b having transmitted the a first trap.

Address conversion apparatus 130a may use the GET REQUEST message based on SNMP as the aforementioned read request message. Further, address conversion apparatus 130a may use the SET REQUEST message or the GET REQUEST message based on SNMP as the aforementioned management message.

Monitoring apparatus 150 of the present embodiment has the same constitution as the first embodiment. Global receiving unit 300 in monitoring apparatus 150 receives the second trap, which is a changed trap transmitted by address conversion apparatus 130a or 130b. Specifying unit 310 analyzes the second trap received by global receiving unit 300 and specifies the address conversion apparatus having transmitted the second trap as one of address conversion apparatuses 130a to 130b. Trap processor 320 processes the second trap corresponding to the first trap. Trap processor 320 generates the request to read the first trap for the address conversion apparatus having transmitted the second trap and transmits the generated request via global transmitting unit 330. Trap processor 320 notifies a user who uses monitoring apparatus 150 of a content of the read first trap, updates information with respect to the status of each of terminals 110a to 110d stored in trap processor 320, or generates a management message to instruct an operation corresponding to the read first trap. Global transmitting unit 330 transmits the request to read the first trap or the management message generated by trap processor 320 to the address conversion apparatus of address conversion apparatuses 130a to 130b having transmitted the second trap.

Monitoring apparatus 150 may use the GET REQUEST message based on SNMP as the aforementioned read request message. Further, monitoring apparatus 150 may use the SET REQUEST message or the GET REQUEST message based on SNMP as the aforementioned management message.

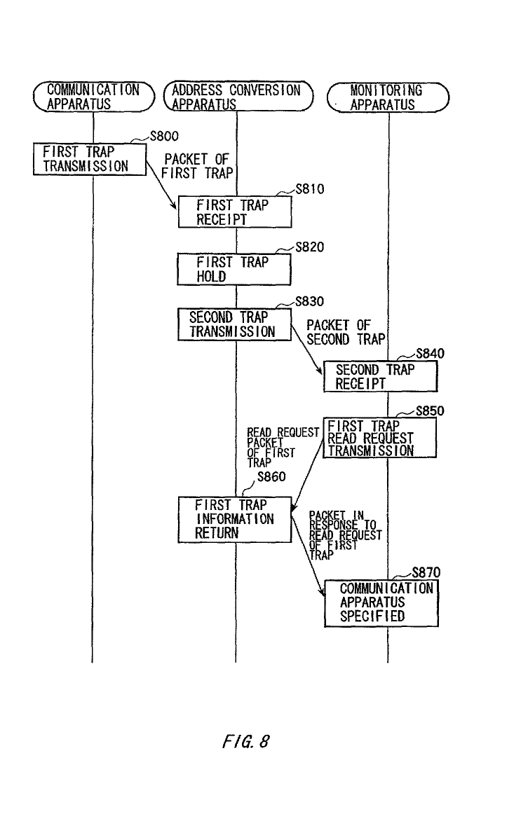

FIG. 8 shows a trap transfer sequence of the second embodiment in the present invention. In the present embodiment, an exemplary case where terminal 110b transmits the first trap will be described.

Terminal 110b transmits the first trap to monitoring apparatus 150 (S800). Address conversion apparatus 130a receives the first trap transmitted by terminal 110b (S810). Holding unit 780 in address conversion apparatus 130a holds the received first trap (S820). Address conversion apparatus 130a transmits the second trap, generated by changing the first trap with converter 210, to monitoring apparatus 150 (S830). The second trap is a trap having agent address part 435 of the first trap changed to “205.177.129.1”.

Monitoring apparatus 150 receives the second trap transmitted by address conversion apparatus 130a (S840). Monitoring apparatus 150 specifies that address conversion apparatus 130a transmitted the second trap based on agent address part 435 of the second trap, and transmits the request to read the first trap to address conversion apparatus 130a (S850).

Address conversion apparatus 130a receives the request to read the first trap transmitted by monitoring apparatus 150 and returns data of the first trap held by holding unit 780 to monitoring apparatus 150 (S860). Monitoring apparatus 150 specifies the communication apparatus having transmitted the first trap based on data of the first trap returned by address conversion apparatus 130a (S870).

According to the present embodiment, converter 210 in address conversion apparatuses 130a to 130b converts the first trap into the second trap. Address conversion apparatuses 130a to 130b hold the first trap. Monitoring apparatus 150 transmits the request to read the first trap by receiving the second trap and thereby can obtain the first trap. Thereby, monitoring apparatus 150 can specify the communication apparatus having transmitted the first trap. Further, since the second trap is also a trap and one part of the first trap is replaced, a change in packet length is not necessary and the packet conversion processing can simply be realized.

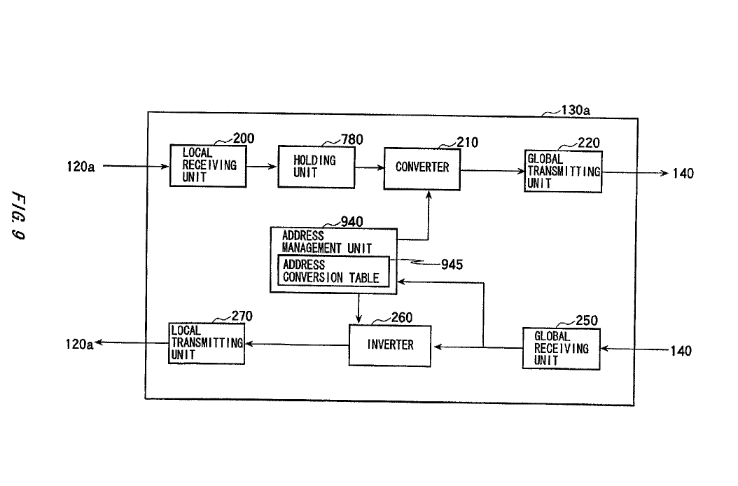

(Third embodiment)FIG. 9 shows components in address conversion apparatus 130a of a third embodiment in the present invention. Address conversion apparatus 130a of the present embodiment includes local receiving unit 200, converter 210, global transmitting unit 220, global receiving unit 250, inverter 260, local transmitting unit 270, holding unit 780, and address management unit 940. Local receiving unit 200 is one example of a receiving unit in address conversion apparatus 130a of the present embodiment. Global transmitting unit 220 is one example of a transmitting unit in address conversion apparatus 130a of the present embodiment. Local transmitting unit 270 is one example of a transfer unit in address conversion apparatus 130a of the present embodiment.

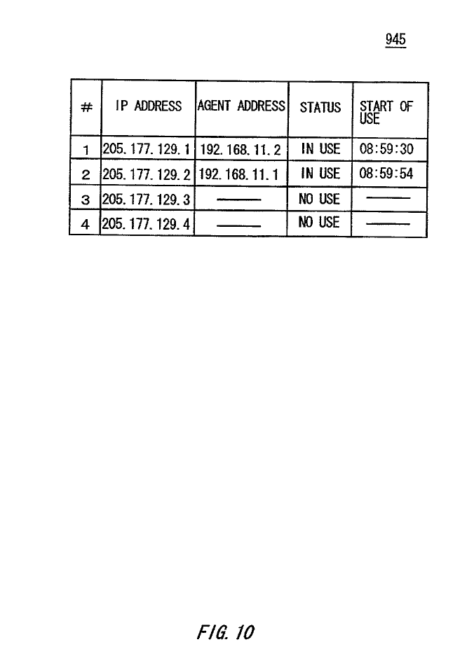

Address management unit 940 manages one or more global IP address allocated to address conversion apparatus 130a and corresponds a content of agent address part 435 of the first trap received by address conversion apparatus 130a to a corresponding global IP address. Address management unit 940 has address conversion table 945 (note FIG. 10). Address conversion table 945 stores correspondence of a content in agent address part 435 of the first trap to the corresponding global IP address.

Local receiving unit 200 receives the first trap, which is an SNMP trap, from terminal 110a to 110b, which are communication apparatuses on LAN 120a. Holding unit 780 holds the first trap received by local receiving unit 200.

Converter 210 obtains a global IP address corresponding to the first trap from address management unit 940. Converter 210 changes agent address part 435 of the first trap to the global IP address obtained from address management unit 940 to generate the second trap.

Global transmitting unit 220 transmits the second trap generated by converter 210 to monitoring apparatus 150 on WAN 140. Global receiving unit 250 receives a management message transmitted by monitoring apparatus 150 to terminal 110a or 110b having transmitted the first trap. Monitoring apparatus 150 transmits the management message to the destination based on agent address part 435 in the second trap.

Inverter 260 converts the management message destination IP address received by global receiving unit 250 into the local IP address of terminal 110a or terminal 110b having transmitted the first trap. Local transmitting unit 270 transmits the management message converted by inverter 260, via LAN 120a, to terminal 110a or terminal 110b having transmitted the first trap. Local transmitting unit 270 transmits a packet of the management message in which the destination address is converted by inverter 260 to terminal 110a or terminal 110b having transmitted the first trap via LAN 120a.

Address conversion apparatus 130a may use, for example, the SET REQUEST message or the GET REQUEST message based on SNMP as the aforementioned management message.

Address conversion apparatus 130a of the present embodiment allocates a global IP address corresponding to agent address part 435 of the first trap. Monitoring apparatus 150 transmits the management message to terminal 110a or 110b by using the global IP address allocated by address conversion apparatus 130a. Once address conversion apparatus 130a receives the management message from monitoring apparatus 150, address conversion apparatus 130a converts the destination global IP address into the corresponding local IP address of terminal 110a or 110b, by using address management unit 940, to transmit the converted management message to terminal 10a or 110b.

Address management unit 940 in address conversion apparatus 130a sets the status of an address used when global transmitting unit 220 transmits the second trap, to a status of “in use”. When the status of all of the addresses managed by address management unit 940 is the status of “in use”, converter 210 does not generate the second trap and waits for address management unit 940 to allocate an address.

FIG. 10 is one example of address conversion table 945 according to the third embodiment in the present invention. Address conversion table 945 according to the present embodiment has an IP address field, an agent address field, a status field, and a start of use field.

The IP address field holds the one or more global IP address allocated to address conversion apparatus 130a. The agent address field holds the local IP address of transmission source shown in agent address part 435 of the first trap received by address conversion apparatus 130a. The status field shows whether or not the corresponding global IP address is used. The start of use field shows a time when use of the corresponding global IP address is started.

For example, first line in FIG. 10 shows that the global IP address “205.177.129.1” is allocated to the first trap received from terminal 110b. Second line in FIG. 10 shows that the global IP address “205.177.129.2” is allocated to the first trap received from terminal 110a. Each of third and fourth lines in FIG. 10 shows that each of the global IP addresses “205.177.129.3” and “205.177.129.4” is not used.

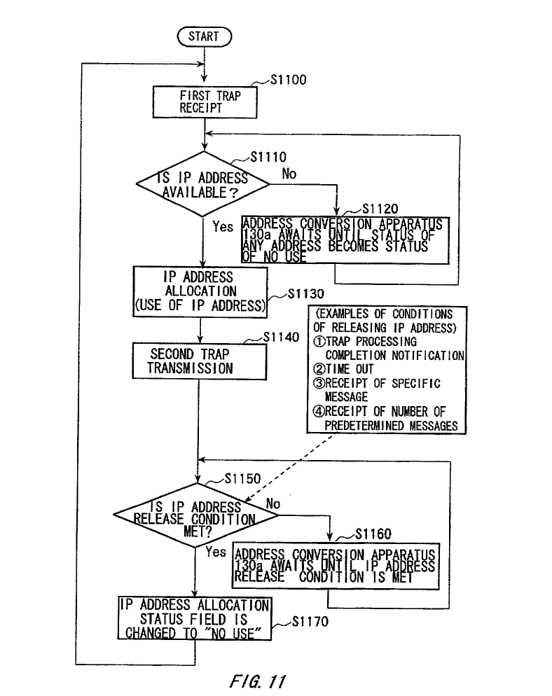

FIG. 11 is a flowchart of a processing in address conversion apparatus 130a according to the third embodiment in the present invention.

First, address conversion apparatus 130a receives the first trap (S1100). Next, address conversion apparatus 130a checks whether or not “no use” of the global IP addresses managed by address management unit 940 exists in the status field (S1110). When “no use” of the global IP addresses does not exist in the status field, address conversion apparatus 130a awaits until status of any address becomes “no use” (S1120).

Address conversion apparatus 130a allocates the global IP addresses of “no use” to terminal 110a or 110b shown in agent address part 435 of the first trap (S1130). At this time, “in use” is shown in the status field of the corresponding global IP address in address conversion table 945 by address conversion apparatus 130a. Address conversion apparatus 130a changes agent address part 435 of the first trap to the allocated global IP address to generate the second trap, and transmits the trap to monitoring apparatus 150 (S1140).

Monitoring apparatus 150 transmits the management message to terminal 110a or terminal 110b having transmitted the first trap by using the global IP address shown in agent address part 435 of the second trap. Address conversion apparatus 130a converts the destination address of management message received from monitoring apparatus 150 by using address management unit 940 and transfers the converted management message to terminal 110a or 110b having transmitted the first trap.

Address conversion apparatus 130a awaits until condition to release the global IP address managed by address management unit 940 is met (S1150, S1160). When condition to release the global IP address is met, address conversion apparatus 130a changes the corresponding status field in address conversion table 945 to “no use” and releases the global IP address (S1170).

Conditions to release the global IP address in S1150 can be realized in various manners.

After the management message is transmitted to terminal 110a or 110b corresponding to the first trap, monitoring apparatus 150 may transmit a message of trap processing completion information to inform completion of trap processing to address conversion apparatus 130a. In this case, address conversion apparatus 130a receives trap processing completion information from monitoring apparatus 150 and sets the status field showing status of the global IP address specified by this message to “no use”. Address conversion apparatus 130a and monitoring apparatus 150 may use the SET REQUEST message or the GET REQUEST message based on SNMP as the aforementioned message of trap processing completion information.

After the status field showing status of the global IP address is set to “in use”, address conversion apparatus 130a detects passage of time specified previously and may set the status field of the global IP address to “no use”. In this case, monitoring apparatus 150 transmits the management message to address conversion apparatus 130a to make address conversion apparatus 130a process the transmitted message until address conversion apparatus 130a sets the status field of the global address to “no use”.

When a specific message or combination of specific messages is received from monitoring apparatus 150, address conversion apparatus 130a may release the global IP address.

When a predetermined number of messages are received from monitoring apparatus 150, address conversion apparatus 130a may release the global IP address.

As described above, according to the present embodiment, address management unit 940 in address conversion apparatuses 130a to 130b allocates the global IP address to the first trap. Monitoring apparatus 150 can transmit the management message to terminals 110a to 110b by using the global IP address. Since the second trap is a trap, one part of the first trap is replaced, change of packet length is not necessary and the packet conversion processing can simplify be realized.

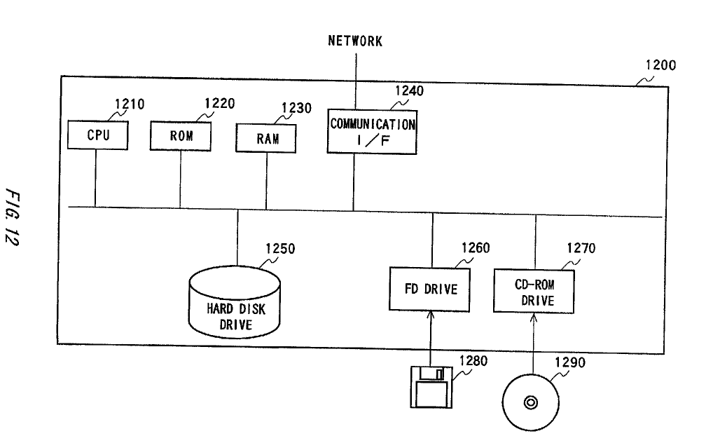

(Fourth embodiment)FIG. 12 shows one example of hardware components in address conversion apparatus 130a or monitoring apparatus 150 of a fourth embodiment in the present invention. A function of address conversion apparatus 130a or monitoring apparatus 150 is realized by association of computer 1200 including CPU 1210, ROM 1220, RAM 1230, communication interface 1240, and hard disk drive 1250 with a program executed in computer 1200. Computer 1200 may further provide with floppy disk drive 1260 and/or CD-ROM drive 1270. Address conversion table 945 in address conversion apparatus 130a is arranged in hard disk drive 1250.

A program to realize address conversion apparatus 130a has a local receiving module, a conversion module, a global transmitting module, a global receiving module, an inversion module, a local transmitting module, a local transmitting module, a holding module, a reading module, an address management module. These modules are programs to make computer 1200 operate as local receiving unit 200, converter 210, global transmitting unit 220, global receiving unit 250, inverter 260, local transmitting unit 270, holding unit 780, reading unit 790, and address management unit 940.

A program to realize monitoring apparatus 150 has the global receiving module, a specifying module, a trap processing module, a global transmitting module. These modules are programs to make computer 1200 operate as global receiving unit 300, specifying unit 310, trap processor 320, and global transmitting unit 330, respectively.

The aforementioned program or module may be stored in an external storage medium. As the storage medium, an optical recording medium such as a DVD or a PD, a magnetic recording medium such as a MD, a tape medium, and a semiconductor memory such as an IC card can be used other than floppy disk 1280 and CD-ROM 1290. A storage device such as the hard disk or the RAM in a server system connected to a dedicated communication network or an Internet is used as a recording medium and the program may be provided in computer 1200 via a network.

Such recording medium is used only to realize address conversion apparatus 130a or monitoring apparatus 150 in computer 1200 and it is obvious that manufacturing and sale etc. as business of the recording medium infringes the present patent right based on the present application.

Functions of programs in computer 1200 may be realized by using a plurality of computers. In this case, various functions in address conversion apparatus 130a or monitoring apparatus 150 may be provided in any positions in the plurality of computers.

With respect to a protocol as defined based on an SNMP in the future, a protocol can be applied to the present invention if the protocol is based on a basic protocol of the SNMP.

According to the present invention, it is possible to simplify a packet converting processing of a trap in an address conversion apparatus for relaying the trap transmitted by a communication apparatus to transfer to a management apparatus.

Although the present invention has been described by way of exemplary embodiments, it should be understood that many changes and substitutions may be made by those skilled in the art without departing from the spirit and the scope of the present invention which is defined only by the appended claims.

1. An address conversion apparatus for connecting a first network to a second network, comprising:
a receiving unit that receives a first SNMP trap from a communication apparatus in said first network;
a converter that changes a predetermined part in said first trap to generate a second SNMP trap; and
a transmitting unit that transmits said second trap generated by said converter to a monitoring apparatus of said communication apparatus in said second network.

2. An address conversion apparatus as claimed in claim 1, wherein said converter changes said predetermined part of an agent address part in said first trap to a value corresponding to an address in said second network to generate said second SNMP trap.

3. An address conversion apparatus as claimed in claim 2, wherein said converter changes said predetermined part of a time stamp part in said first trap to information for identifying said communication apparatus in said first network to generate said second trap.

4. An address conversion apparatus as claimed in claim 2, wherein said converter changes said predetermined part of a port number in said first trap to information for identifying said communication apparatus in said first network to generate said second trap.

5. An address conversion apparatus as claimed in claim 1, wherein said converter changes said predetermined part in said first trap to information for identifying said address conversion apparatus to generate said second SNMP trap.

6. An address conversion apparatus as claimed in claim 5, wherein said converter changes said predetermined part of a time stamp part in said first trap to said information for identifying said address conversion apparatus to generate said second trap.

7. An address conversion apparatus as claimed in claim 5, wherein said converter changes said predetermined part of a port number in said first trap to said information for identifying said address conversion apparatus to generate said second trap.

8. An address conversion apparatus for connecting a first network to a second network, comprising:
a receiving unit that receives a first SNMP trap from a communication apparatus in said first network;
a holding unit that holds said first trap;
a transmitting unit that transmits a second SNMP trap based on said first SNMP trap to a monitoring apparatus of said communication apparatus in said second network; and
a reading unit that reads said first trap from said holding unit in response to a read request of said first trap, corresponding to said second trap, from said monitoring apparatus, and transmits said first trap to said monitoring apparatus.

9. An address conversion apparatus for connecting a first network to a second network, comprising:
an address management unit that manages one or more addresses allocated to said address conversion apparatus;
a receiving unit that receives a first SNMP trap from a communication apparatus in said first network;
a holding unit that holds said first trap;
a converter that changes an agent address part in said first trap to one of said one or more addresses managed by said address management unit to generate
a second SNMP trap; and
a transmitting unit that transmits said second trap generated by said converter to a monitoring apparatus in said second network, wherein
said address management unit sets a status of said one of said one or more addresses to generate said second trap to “in use”, and
when a status of each of said one or more addresses managed by said address management unit is “in use”, said converter does not generate said second trap.

10. An address conversion apparatus as claimed in claim 9, wherein said address management unit receives, from said monitoring apparatus, trap processing completion information for setting said “in use” status of said one or more addresses to “no use”, and sets said status of said one or more addresses specified by said trap processing completion information to “no use”.

11. An address conversion apparatus as claimed in claim 9, wherein after said status of said one or more addresses is set to “in use”, said address management unit detects a previously specified passage of time and sets said “in use” status of said one or more addresses to “no use”.

12. An address conversion apparatus as claimed in claim 9, wherein said address management unit obtains an agent address from said first trap received from said communication apparatus in said first network, and records correspondence of said agent address to said one of said one or more addresses to generate said second trap, and wherein
said address conversion apparatus further comprises:
an inverter that changes a destination address of a first packet from said monitoring apparatus to said agent address, when said destination address of
said first packet from said monitoring apparatus is said one of said one or more addresses managed by said address management unit, to generate a second packet; and
a transfer unit that transfers said second packet to said communication apparatus in said first network.

13. A monitoring apparatus receiving an SNMP trap transmitted by a communication apparatus via an address conversion apparatus, wherein said monitoring apparatus includes a specifying unit that specifies said communication apparatus based on an agent address part and a time stamp part in said trap.

14. A monitoring apparatus receiving an SNMP trap transmitted by a communication apparatus via an address conversion apparatus, wherein said monitoring apparatus includes a specifying unit that specifies said communication apparatus based on an agent address part and a port number in said trap.

15. A monitoring apparatus receiving a generated SNMP trap from an address conversion apparatus, connecting a first network to a second network, which receives an SNMP trap from a communication apparatus in said first network, holds said trap, and transmits said generated trap, said monitoring apparatus comprising:
a receiving unit that receives said generated trap; and
a transmitting unit that transmits a request to said address conversion apparatus to read said trap corresponding to said generated trap from said address conversion apparatus.

16. A computer-readable medium storing an address conversion program for a computer connecting a first network to a second network, the program comprising:
a receiving module that directs said computer to receive a first SNMP trap from a communication apparatus in said first network;
a conversion module that directs said computer to change a predetermined part in said first trap to generate a second SNMP trap; and
a transmitting module that directs said computer to transmit said second trap generated by said computer to a monitoring apparatus of said communication apparatus in said second network.

17. A computer-readable medium storing a program for a monitoring apparatus that receives an SNMP trap transmitted by a communication apparatus via an address conversion apparatus, wherein said program comprises a specifying module that is operable to make said monitoring apparatus specify said communication apparatus based on an agent address part and a time stamp part in said trap.

18. A computer-readable medium storing a program for a monitoring apparatus that receives an SNMP trap transmitted by a communication apparatus via an address conversion apparatus, wherein said program comprises a specifying module that is operable to make said monitoring apparatus specify said communication apparatus based on an agent address part and a port number in said trap.
